(19) United States
(12) Patent Application Publication
(10) Pub. No.: US 2008/0045226 A1
(43) Pub. Date: Feb. 21, 2008

(54) Method for Allocating Channel Processing Resources and Centralized Base Stations for Implementing the Same

(76) Inventor: Sheng Liu, Shenzhen, Guangdong (CN)

Correspondence Address: LADAS & PARRY LLP, 224 SOUTH MICHIGAN AVENUE, SUITE 1600, CHICAGO, IL, 60604, US

(21) Appl. No.: 11/658,656

(22) PCT Filed: Jul. 28, 2004
(86) PCT No.: PCT/CN04/00875

§ 371 Date: Jun. 20, 2007

(51) Int. Cl. H04Q 7/20

(52) U.S. Cl. 455/450

(57) ABSTRACT

The present invention provides a method of allocating channel processing resources of radio links one by one in a centralized base station, comprising the step of: allocating channel resources with a radio link as a unit, according to resource allocation requirements of a wireless communication system in which said centralized base station is located, so as to respectively allocate uplink and downlink wireless signals of corresponding cells in said centralized base station to at least one channel processing unit in the centralized base station, so that the allocated channel processing units perform service channel processing of a part of users of the corresponding cells, respectively. The present invention further provides a centralized base station for implementing the above method. The method and the centralized base station allocate channel resources with a radio link as a unit and allows uplink and downlink wireless signals of one cell to be simultaneously allocated to at least one channel processing unit so as to respectively perform service channel processing of a part of users of the cell, thereby maximizing utilization of channel processing resources and realizing flexible allocation of channel processing resources.

### FIELD OF TECHNOLOGY

The present invention relates to the technical field of distributed base stations in a mobile communications system. In particular, the present invention relates to a method for allocating channel processing resources of radio links one by one in a centralized base station system using a remote radio unit (RRU), and centralized base stations supporting this method.

### BACKGROUND ART

1. Overview of Centralized Base Stations

In a mobile communications system, a base transceiver station (BTS) carries out transmission, reception and processing of wireless signals. A traditional BTS mainly consists of a base band processing subsystem, an RF subsystem and antennas, and one BTS can cover different cells via a plurality of antennas, as shown in FIG. 1(a); the STSs are connected to a base station controller (BSC) or a radio network controller (RNC) via certain interfaces, respectively, thereby constituting a radio access network (RAN), as shown in FIG. 1(b).

FIG. 2 shows system architecture of another type of distributed base station, i.e., a centralized base station using an RRU. Compared with a traditional base station, this centralized base station using an RRU has many advantages: one macro-cell based on the traditional base station is allowed to be replaced with a plurality of micro-cells, so as to be well adapted to different wireless environments and to improve capacitance, coverage and other wireless performances of the system; owing to such a centralized structure, a soft handover is caused to be performed using a softer handover thereby to obtain extra processing gains; owing to such a centralized structure, expensive base band signal processing resources are caused to be a resource pool shared by a plurality of cells, thereby obtaining statistic multiplexing benefits and effectively reducing system costs. PCT patent application No. WO9005432, titled “Communications System”, U.S. Pat. No. 5,657,374, titled “Cellular System with Centralized Base Stations and Distributed Antenna Units”, U.S. Pat. No. 6,324,391, titled “Cellular Communication with Centralized Control and Signal Processing”, China patent application No. CN1471331, titled “Mobile Communications Base Station System”, and U.S. patent application No. US20030171118, titled “Cellular Radio Transmission Apparatus and Cellular Radio Transmission Method”, etc. all reveal relevant implementing details of that technique.

As shown in FIG. 2, the centralized base station system using an RRU mainly consists of a central channel processing master unit (MU) 10 and a plurality of remote radio units (RRUs) 20 that are provided in a centralized manner, and they are connected with each other via a wideband transmit link or a network, whereas a BSC/RNC interface unit is responsible for carrying out processing of a user plane and a signalling plane of interfaces between the BTSs and the BSC/RNC. The central channel processing master unit (MU) is mainly comprised of a channel processing resource pool, a signal routing allocating unit and other functionality units, wherein the channel processing resource pool is formed by stacking a plurality of channel processing units and performs base band signal processing and other jobs, and the signal routing allocating unit routes or exchanges wireless signals corresponding to the respective RRUs to corresponding channel processing units according to an allocation result of channel processing resources, so that the processing resources can be effectively shared by plural cells. The signal routing allocating unit, besides being realized inside the MU as shown in FIG. 2, can also be realized outside the MU as a single device. The RRU is mainly constituted of a transmit channel RF power amplifier, a receive channel low-noise amplifier, antennas and other functionality units. The links between the central channel processing master unit 10 and the RRUs typically utilize optical fibers, copper cables, microwaves and other transmission media; a signal transmission may take the forms of sampled digital signals or modulated analog signals; signals can be base band signals, intermediate frequency signals or RF signals.

From the foregoing introductions of the prior art, it is easy to find that a primary advantage of the centralized base station lies in enabling the base band signals processing resources to be a resource pool shared by plural cells, thereby obtaining statistic multiplexing benefits and effectively reducing system cost. Thus, how to effectively allocate and utilize the channel processing resources is a key for making best of the advantage of the centralized base station.

2. Channel Processing Resources and Centralized Base Station Architecture

In a code division multiple access (CDMA) system, the base band signal processing resources mainly consist of a chip-level processing unit using a RAKE receiver or other enhanced receive techniques such as multi-user detection (MUD) as a core, and a symbol-level processing unit using a channel CODEC processing as a core, wherein the symbol-level processing is closely related to user service type and rate relationship, whereas the chip-level processing is little affected by the user service type and the rate relationship but is primarily associated with the number of service channels.

In a large-scale base station system which supports multiple sectors and multiple carrier frequencies, a channel processing function section typically has two possible architectures, wherein one is realized by integrating chip-level processing units and symbol-level processing units on a single board, that is, the system consists of a plurality of channel processing modules the number of which can be configured; the other is realized by providing chip-level processing units and symbol-level processing units on different boards, respectively, that is, the system consists of a plurality of chip-level processing modules and symbol-level processing modules the number of which can be configured. FIGS. 3 and 4 show typical implementing examples of the above two architectures.

In a typical example of the system architecture formed by integrating chip-level processing units and symbol-level processing units as shown in FIG. 3, the system consists of M independent channel processing modules, and the so-called “independent” indicates that these channel processing modules perform their respective channel processing tasks without any internal signal interconnection. Without internal signal interconnection, the design of the backboard bus of the system is caused to be greatly simplified, which is conducive to forming a large-scale centralized base station. The independence between the modules is not conducive to the effective utilization of system resources, but the prior-art solutions to the base band signal processing also have an all-software implementing solution based on a digital signal processor (DSP) or a structure formed by a plurality of arrays of micro-processing units for parallel processing. Owing to software flexibility in the processor resource scheduling, the deficiency of the structure with regard to the effective utilization of system resources is greatly lessened.

In a typical example of the system architecture, with chip-level processing units and symbol-level processing units separated, as shown in FIG. 4, the system consists of P chip-level processing modules and Q symbol-level processing modules, wherein the chip-level processing modules are independent of each other, that is, they perform their respective chip-level processing tasks without any internal signal interconnection. The chip-level processing rate is very high, so the internal signal interconnection between the chip-level processing modules will cause the system architecture complicated and it is hard to be applied in the large-scale centralized base station; on the other hand, due to a relatively low rate, the symbol-level processing modules allow the internal signal interconnection so as to realize the sharing of processing resources, so a symbol-level processing section can be regarded as a consecutive and single processing module.

Thus, the above-mentioned two typical implementing architectures have a problem that the channel processing resources are not continuous, that is, the channel processing resources are constituted by a plurality of incontinuous channel processing units. On the other hand, in an ordinary base station system, the allocation of the channel processing resources is static and the channel processing of one cell is usually performed by a fixed channel processing unit, that is, uplink and downlink wireless signals of one cell are uniquely routed or exchanged to a certain channel processing unit and this channel processing unit is responsible for service channel processing of all the users of the cell. However, in the centralized base station system, in order to support the flexible dynamic allocation of the channel processing resources, due to incontinuity of the channel processing resources, allocating the channel processing resources with one cell as a unit will result in large channel processing resource fragments that cannot be utilized, thereby causing a waste of channel processing resources.

### SUMMARY OF THE INVENTION

According to the above analysis, due to incontinuity of channel processing resources in centralized base stations, allocating the channel processing resources with one cell as a unit in a traditional base station system will result in large channel processing resource fragments that cannot be utilized, which is not beneficial to effective utilization of the channel processing resources.

In view of the above problems existing in the prior art, one object of the present invention is to provide a method of allocating channel processing resources of radio links one by one in a centralized base station. In the method according to the present invention, the channel resources are allocated with a radio link as a unit. Thus, the centralized base station allows uplink and downlink radio signals of one cell to be simultaneously allocated to at least one channel processing unit so as to perform service channel processing of a part of users of the cell, thereby maximizing utilization of the channel processing resources and supporting a flexible channel processing resource allocation strategy.

Another object of the present invention is to provide a centralized base station architecture supporting the above allocating method, which is capable of realizing effective allocation of the channel processing resources and improving the utilization of the channel processing resources.

In order to realize the above objects of the present invention, a first aspect of the present invention provides a method of allocating channel processing resources of radio links one by one in a centralized base station, the method comprising the step of:

allocating channel resources with a radio link as a unit, according to resource allocation requirements of a wireless communication system in which said centralized base station is located, so as to respectively allocate uplink and downlink wireless signals of corresponding cells in said centralized base station to at least one channel processing unit in the centralized base station, so that the allocated channel processing units perform service channel processing of a part of users of the corresponding cells, respectively.

In an embodiment of the above method of allocating channel processing resources according to the present invention, the step of allocating channel resources with a radio link as a unit further comprises the step of selecting a corresponding channel processing unit for each radio link in said corresponding cells, so that the channel processing associated with said each radio link is performed in the selected corresponding channel processing unit, respectively, and uplink and downlink wireless signals in said corresponding cells are respectively allocated to at least one of the selected channel processing unit.

A second aspect of the present invention provides a centralized station for implementing the foregoing method of allocating channel processing resources of radio links one by one, comprising:

a central channel processing master unit MU including a channel processing resource pool consisting of a plurality of channel processing units;

a plurality of remote radio units RRUs each being coupled to the central channel processing master unit MU via a wideband transmit link or a network;

a signal routing allocating unit for routing or exchanging wireless signals corresponding to the RRUs to corresponding channel processing units according to an allocation result of the channel processing resources;

characterized in that said centralized base station further comprises:

a channel processing resource allocating and control unit configured to

allocate channel resources with a radio link as a unit, according to resource allocation requirements of a wireless communications system in which said centralized base station is located, thereby allocating uplink and downlink wireless signals of a corresponding cell in said centralized base station to at least one channel processing unit in said centralized base station, respectively, and control the allocated channel processing units to perform service channel processing of part of users of the corresponding cell, respectively.

In an embodiment of the foregoing centralized base station according to the present invention, said channel processing resource allocation and control unit is further configured to select a corresponding channel processing unit for each radio link in said corresponding cells, so that the channel processing associated with said each radio link is carried out in the selected corresponding processing unit, respectively, and uplink and downlink wireless signals of said corresponding cells are allocated to at least one selected channel processing unit, respectively.

Need to explain that, though the present invention is described by taking a CDMA system as an example, the fundamental ideas, spirit, principles and methods of the present invention are still applicable to mobile communications systems of other types, such as FDMA, TDMA, OFDMA and the like.

### BRIEF DESCRIPTION OF THE ACCOMPANYING DRAWINGS

Referring to detailed illustrations of the drawings for the specific embodiments in the present invention, the features and advantages of the present invention will become more apparent. In the drawings,

FIG. 1(a) shows a traditional BTS architecture;

FIG. 1(b) shows a traditional radio access network architecture;

FIG. 2 shows a system architecture of a centralized base station using an RRU;

FIG. 3 shows a system architecture of the prior-art base station system in which chip-level processing units and symbol-level processing units are integrated in a channel processing function section;

FIG. 4 shows a system architecture of the prior-art base station system in which chip-level processing units and symbol-level processing units are separated in a channel processing function section; and

FIG. 5 is a view showing production of downlink digital baseband I/Q signals in a CDMA system, according to an embodiment of the method of allocating channel processing resources of the present invention.

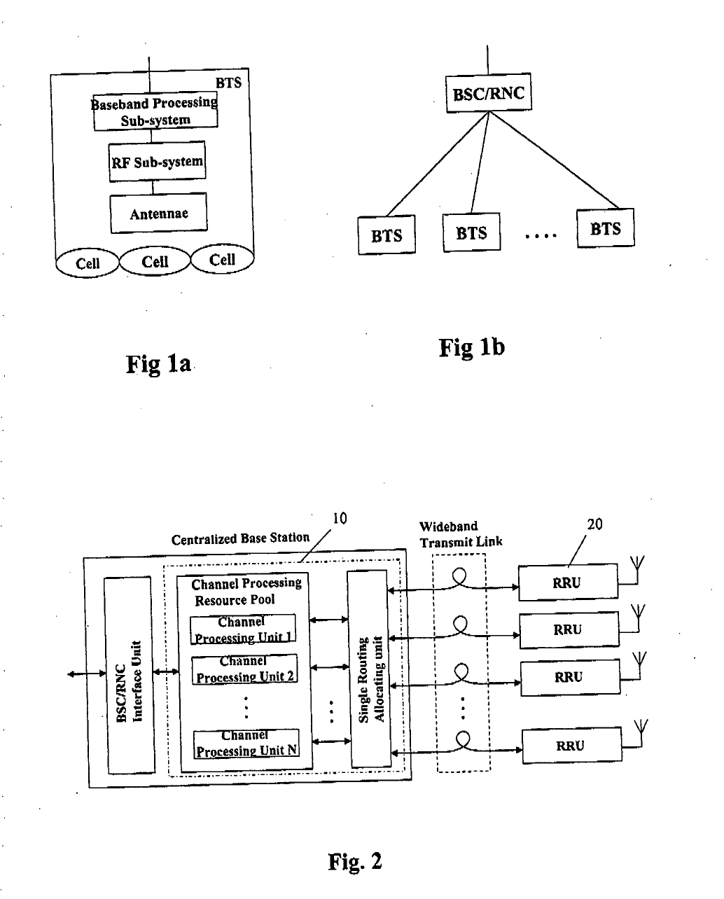

### BEST MODE FOR CARRYING OUT THE INVENTION

Referring to the accompanying drawings, specific modes for carrying out the present invention will be described in detail below.

Since wireless signals of the same RRU contain physical channels of plural mobile terminals, in order to realize dynamic resource allocation of radio links one by one, it is necessary for the signal routing allocating unit in the centralized base station to support simultaneously routing or exchanging wireless signals of the same RRU to a plurality of different channel processing units so as to process the physical channels of the different mobile terminals, respectively. Those skilled in the art can easily meet the technical requirements of the signal routing allocating unit by means of known techniques, which is not described in detail here. On this basis, two modes for implementing the allocation of channel processing resources of radio links one by one in the present invention are introduced below.

Mode 1: Processing of uplink and downlink physical channels are performed by correspondingly the same channel processing units.

Owing to the application of the feedback control technique in a physical layer, typically such as inner-loop power control, closed-loop transmit diversity, mixed-type ARQ (Automatic Repeat Request) and the like, generation and processing of uplink and downlink signals are caused to be closely related. Thus, in a preferred embodiment of this implementation mode of the present invention, processing of uplink and downlink physical channels of the same mobile terminal are performed by the same channel processing unit.

In this implementation mode of the present invention, channel resources are allocated with a radio link as a unit, according to system resource allocation requirements, so that uplink and downlink wireless signals of one cell can be simultaneously allocated to one or more different channel processing units, and the corresponding channel processing units carries out processing of a corresponding part of service channels of the cell, respectively. In the uplink direction, these channel processing units are respectively responsible for processing of uplink physical channels to which a part of mobile terminals corresponds in uplink wireless signals of the cell, and the channel processing results are respectively sent to a user plane processing section of an interface unit between the base station and the RNC/BSC to form uplink data frames. In the downlink direction, these channel processing units respectively carry out processing of downlink physical channels to which the uplink physical channels of the corresponding mobile terminals correspond in downlink wireless signals of the cell, and downlink wireless signal components of the cell from the different channel processing units are added up on the premise of guaranteed timing alignment thereof, thereby compounding entire downlink wireless signals of the cell. Thus, in the foregoing signal allocation and processing operations, part of channel processing tasks of wireless signals of the same cell can be performed by a plurality of channel processing units, respectively, so that the allocation of the channel processing resources become quite flexible. Therefore, it is possible to perform dynamic allocation of resources for radio links one by one according to a system processing resource status, thereby decreasing processing resource fragments which may probably occur and improving utilization of the processing resources.

In addition, in an embodiment of the first implementation mode of the method of allocating channel processing resources of radio links one by one according to the present invention, a corresponding channel processing unit is selected for each radio link of corresponding cells in the centralized base station, and uplink and downlink wireless signals of said corresponding cells are respectively allocated to these channel processing units for channel processing. Those skilled in the art know various methods in the prior art can be adopted here to realize the selecting operation of the channel processing units. Preferably, it is possible to realize selection of an optimum channel processing unit for each newly-added radio link using the method set forth in “Resource Allocation and Signal Routing Method in Centralized Base Stations” filed by the same applicant on Jun. 10, 2004, so that the channel processing associated with each newly-added radio link is performed in the selected optimum channel processing unit. The full text of the above application for a patent is cited here for reference.

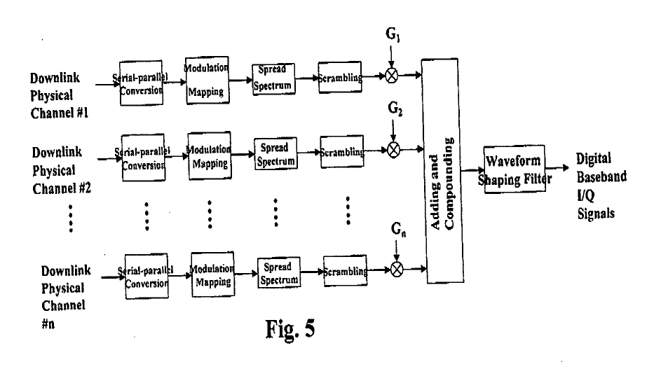

FIG. 5 shows a typical example of a process in which physical channels of a certain cell in a CDMA system are generated and form downlink digital baseband I/Q signals, according to an embodiment of the first implementation mode. As shown in FIG. 5, G₁, G₂, . . . Gₙ represent gains of respective channels. It is not hard to see that, the waveform shaping filtering is a linear system, so the waveform shaping filtering operation can be either performed after respective physical channels are modulated (constellation mapped), spread-spectrum, scrambled and the like and linearly added, or performed by grouping physical channels, wherein each group is modulated (constellation mapped), spread-spectrum, scrambled, linearly added and waveform shaping filtered, and the respective groups of signals are finally added and compounded to entire downlink signals of the cell. Thus, according to the present invention, when downlink wireless signals of a certain cell adopt the signal allocation and processing operations in the first mode, it is possible to perform the waveform shaping filtering processing by means of the respective channel processing units and finally compound the signals into the entire downlink radio signals of the cell, while it is also possible not to perform the waveform shaping filtering processing in the channel processing units but initially compound the signals into one path of signals and then perform the waveform shaping filtering processing. The above signal compounding, i.e., the adding operation can be carried out by either the signal routing allocating unit or other independent functionality units, but the waveform shaping filtering can be implemented either in the signal routing allocating unit, or by a single unit outside the signal routing allocating unit, or in the RRU.

Still taking the CDMA system as an example, typically, uplink wireless signals of one cell contain a plurality of uplink physical channels which are spread-spectrum by uplink complex scrambling codes, while downlink wireless signals contain a plurality of downlink physical channels which are spread-spectrum by orthogonal spread spectrum codes. When wireless signals of one cell utilize signal allocation and processing operations in the aforesaid first mode, uplink and downlink wireless signals of the cell are simultaneously allocated to a plurality of channel processing units; in the uplink direction, the channel processing units respectively perform processing of a part of uplink physical channels therein, including match filtering, de-spreading, channel estimation, RAKE combination, signal-to-interference ratio (SIR) estimation, de-interleaving, de-multiplexing and channel decoding and the like; in the downlink direction, the channel processing units respectively perform processing of the corresponding part of downlink physical channels, including channel coding, multiplexing, interleaving, rate matching, modulation (constellation mapping, QPSK, 8PSK, and 16QAM, etc.), spread-spectrum, scrambling, waveform shaping filter and other operations. Finally, a part of downlink wireless signal components which are generated respectively are added up to generate entire downlink signals of the cell. Alternatively, the channel processing units respectively perform the above corresponding processing operations of the corresponding part of downlink physical channels, without including the waveform shaping filtering processing, but they are initially compounded into one path of signals and then the waveform shaping filtering processing is performed. As above described, the wireless signal component adding operation can be carried out by the signal routing allocating unit or other independent functionality unit, while the waveform shaping filtering can be realized either in the signal routing allocating unit, or by a single unit outside the signal routing allocating unit, or in the RRU.

Moreover, the processing of uplink physical channels and the processing of the downlink physical channels in the cells are performed by correspondingly the same channel processing units, respectively, in the preferred embodiment of the first implementation mode, but those skilled in the art understand that it is also allowable to allocate different channel processing units for the processing of uplink physical channels and the processing of downlink physical channels of the cells, respectively.

Mode 2: Processing of uplink and downlink physical channels are separate.

The other mode for implementing the method of allocating channel processing resources of radio links one by one as set forth in the present invention is to separate the processing of the uplink and downlink physical channels, that is, allowing the processing of uplink physical channels and the processing of downlink physical channels to be performed by different channel processing units, respectively.

According to this mode of the present invention, in the downlink direction, downlink physical channels of all the radio links of a certain cell are always processed in the same channel processing unit. In this mode, channel resources are allocated with a radio link as a unit, according to system resource allocation requirements, so that uplink wireless signals of one cell can be simultaneously allocated to one or more different channel processing units and the corresponding channel processing units perform processing of a corresponding part of uplink service channels of the cell. These channel processing units are respectively responsible for processing of uplink physical channels to which a part of mobile terminals corresponds in uplink wireless signals of the cell, and the channel processing results are respectively sent to a user plane processing section of an interface unit between the base station and the RNC/BSC to form uplink data frames. However, in the downlink direction, processing of downlink physical channels of all the radio links of the cell are always performed in the same channel processing unit, thus directly forming entire downlink wireless signals of the cell, needless to perform the adding and compounding operation on downlink wireless signal components of one cell from different channel processing units as stated in the first mode. The uplink and downlink physical channels are separately processed and the channel processing resources are allocated for radio links one by one only in light of the uplink channel processing, this mode avoids the adding and compounding operation on downlink wireless signal components of one cell from different channel processing units. In fact, on one hand, the processing of uplink wireless signals needs to occupy most of system processing resources, so the dynamic allocation of channel processing resources is practical for realizing effective load sharing and improving resource utilization in the processing of uplink wireless signals. On the other hand, since the processing of downlink wireless signals relatively occupies little system processing resources, not performing the load sharing will not exert negative influence on the utilization of system processing resources. Thus, the second implementation mode, besides improving the utilization of system channel processing resources, is further capable of obtaining the benefit of simplifying system architecture, especially the centralized base station architecture.

Likewise, in an embodiment of the second implementation mode of the method of allocating channel processing resources of radio links one by one according to the present invention, similar to that of the first implementation mode, a corresponding channel processing unit is selected for each radio link of a corresponding cell in a centralized base station, and uplink and downlink wireless signals of said corresponding cell are respectively allocated to these selected channel processing units for channel processing. In addition, preferably, the method proposed in the above-cited patent application can also be utilized to select an optimum channel processing unit for each newly-added radio link.

In the foregoing two implementation modes of the method of allocating channel processing resources of radio links one by one according to the present invention, a corresponding channel processing unit is allocated to each radio link of all the cells in the discussed centralized base station, but it is also possible to utilize other modes to implement allocation of channel processing resources with a radio link as a unit. For example, it is possible to allocate channel processing units to selected cell in all the cells in said centralized base station according to the utilization situation of system channel resources, and still to allocate fixed channel processing units for the remaining cells; alternatively, it is possible to allocate corresponding channel processing units to a plurality of radio links selected in the selected cells based on the utilization situation of system channel resources, so as to perform processing of uplink and downlink wireless signals in the corresponding cells in said centralized base station. Since it is possible to selectively perform dynamic allocation of channel processing resources for certain cells in said centralized base station and/or for certain radio links in the cells based on the practical situation, this implementation mode may have extra flexibility.

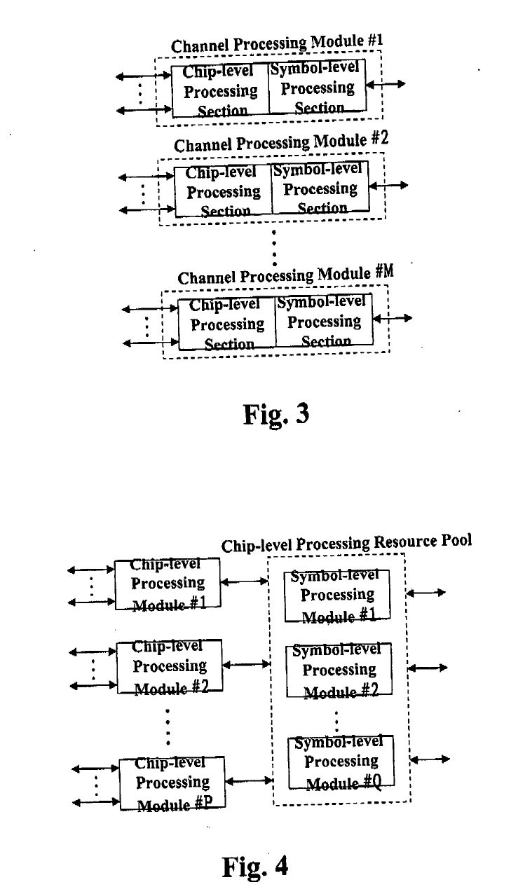

Those skilled in the art should understand that, the foregoing method in the present invention can be implemented by known software, hardware or the combination thereof. Thus, the present invention further provides a centralized base station capable of implementing the above method. In this centralized base station, a channel processing resource allocating and control unit is correspondingly set for allocating uplink and downlink wireless signals of cells associated with said centralized base station to at least one channel processing unit in said centralized base station according to allocation requirements of wireless communication system resources, and controlling the allocated channel processing units to respectively perform service channel processing of a part of users of a corresponding cell, so as to dynamically allocate system channel processing resources for the uplink and downlink physical channels associated with the uplink and downlink wireless signals of the cells, thereby realizing allocation of channel processing resources of radio links one by one. It is easy to understand that the channel processing resource allocating and controlling unit can also be realized by various known functionality modules and can be set for example within the MU 10 as shown in FIG. 3 or outside the centralized base station, etc. Furthermore, the centralized base station comprises a signal compounding unit for adding up downlink wireless signal components of the cells from different channel processing units on the premise of guaranteed timing alignment thereof, thereby compounding entire downlink wireless signals of the corresponding cells, respectively. The signal compounding unit can be set in said signal routing allocating unit, or can be a functionality unit independent of said signal routing allocating unit. This centralized base station further comprises a waveform shaping filtering unit for performing waveform shaping filtering operation in the process of forming downlink wireless signals of the cells. This waveform shaping filtering unit can be set in the signal routing allocating unit of the centralized base station or in a remote radio (RRU), or can be a functionality unit independent of said signal routing allocating unit.

The technical solutions in the present invention have been described above in conjunction with the embodiments. However, those skilled in the art appreciate that, without departing from the principles and spirit of the present invention, varied improvements or transformations can further be made to the present invention. Anyway, the scope of the present invention is only determined by the accompanying claims.

What is claimed is:

1. A method of allocating channel processing resources of radio links one by one in a centralized base station, characterized in that said method comprises the step of:
allocating channel resources with a radio link as a unit, according to resource allocation requirements of a wireless communication system in which said centralized base station is located, so as to respectively allocate uplink and downlink wireless signals of corresponding cells in said centralized base station to at least one channel processing unit in the centralized base station, so that the allocated channel processing units perform service channel processing of a part of users of the corresponding cells, respectively.

2. The method of allocating channel processing resources according to claim 1, characterized in that the step of allocating channel resources with a radio link as a unit further comprises the step of selecting a corresponding channel processing unit for each radio link in said corresponding cells, so that the channel processing associated with said each radio link is performed in the selected corresponding channel processing unit, respectively, and uplink and downlink wireless signals in said corresponding cells are respectively allocated to at least one of the selected channel processing units.

3. The method of allocating channel processing resources according to claim 1, characterized in that said corresponding cells are all the cells associated with said centralized base station, and wherein
in the uplink direction, the channel processing units allocated respectively for the uplink wireless signals of the cells perform processing of uplink physical channels corresponding to corresponding mobile terminals in the uplink wireless signals of the cells, respectively, and then processing results of the channel processing units are respectively sent to a user plane processing section of an interface unit between said centralized base station and an RNC/BSC to form uplink data frames; and
in the downlink direction, the channel processing units allocated respectively for the downlink wireless signals of the cells perform processing of the downlink physical channels corresponding to the uplink physical channels of the corresponding mobile terminals in the downlink wireless signals of the cells, respectively, and then downlink wireless signal components of the cells from different channel processing units are respectively added up on the premise of guaranteed timing alignment, thereby compounding entire downlink wireless signals of the corresponding cells.

4. The method of allocating channel processing resources according to claim 1, characterized in that at least one channel processing unit allocated respectively for the uplink wireless signals of the corresponding cells is the same as at least one channel processing unit allocated respectively for the downlink wireless signals of said corresponding cells.

5. The method of allocating channel processing resources according to claim 1, characterized in that said corresponding cells are all the cells associated with said centralized base station, and wherein
in the uplink direction, the channel processing units allocated respectively for the uplink wireless signals of the cells perform the processing of the uplink physical channels corresponding to corresponding mobile terminals in the uplink wireless signals of the cells, respectively, and then processing results of the corresponding channel processing units are respectively sent to a user plane processing section of an interface unit between said centralized base station and an RNC/BSC to form uplink data frames; and
in the downlink direction, the correspondingly same channel processing units allocated respectively for the downlink wireless signals of the cells perform processing of the downlink wireless signals of the corresponding cells, respectively, so as to form downlink wireless signals of the cells.

6. The method of allocating channel processing resources according to claim 1, characterized in that said corresponding cells are cells selected from all the cells associated with said centralized base station, and the remaining cells are still allocated with fixed channel processing units, and corresponding channel processing units are allocated for a plurality of radio links selected from said corresponding cells based on the utilization situation of system channel resources, so that the allocated channel processing units perform service channel processing of a part of users associated with the selected radio links in said corresponding cells, respectively.

7. The method of allocating channel processing resources according to claim 1, characterized by selecting an optimum channel processing unit for each newly-added radio link, so that the channel processing associated with each newly-added radio link is performed in the selected optimum channel processing unit, respectively.

8. The method of allocating channel processing resources according to claim 1, characterized in that in the process of forming downlink wireless signals of the corresponding cells, the corresponding channel processing units allocated for the corresponding cells respectively perform a waveform shaping filtering processing, and then directly compound entire downlink wireless signals of the corresponding cells.

9. The method of allocating channel processing resources according to claim 1, characterized in that in the process of forming downlink wireless signals of the corresponding cells, signals processed respectively by the corresponding channel processing units allocated for the corresponding cells are compounded into one path of signals, and then a waveform shaping filtering processing of said compounded signals is performed to form entire downlink wireless signals of the corresponding cells, respectively.

10. The method of allocating channel processing resources according to claim 1, characterized in that
the channel processing units allocated for the corresponding cells perform the following processing operations of a part of downlink physical channels associated with said corresponding cells, respectively: channel coding, multiplexing, interleaving, rate matching, modulation, spread-spectrum, scrambling, and waveform shaping filtering processing.

11. The method of allocating channel processing resources according to claim 1, characterized in that
the channel processing units allocated for the corresponding cells perform the following processing operations of a part of uplink physical channels associated with said corresponding cells, respectively: match filtering, de-spreading, channel estimation, RAKE combining, signal-to-interference ratio SIR estimation, de-interleaving, de-multiplexing and channel decoding operation.

12. A centralized station for implementing allocation of channel processing resources of radio links one by one, comprising:
a central channel processing master unit MU (10) including a channel processing resource pool consisting of a plurality of channel processing units;
a plurality of remote radio units (RRU) (20) each being coupled to the central channel processing master unit MU via a wideband transmit link or a network;
a signal routing allocating unit for routing or exchanging wireless signals corresponding to the RRUs to corresponding channel processing units according to an allocation result of the channel processing resources;
characterized in that said centralized base station further comprises:
a channel processing resource allocating and control unit configured to
allocate channel resources with a radio link as a unit, according to resource allocation requirements of a wireless communications system in which said centralized base station is located, thereby allocating uplink and downlink wireless signals of a corresponding cell in said centralized base station to at least one channel processing unit in said centralized base station, respectively, and control the allocated channel processing units to perform service channel processing of part of users of the corresponding cell, respectively.

13. The centralized base station according to claim 12, characterized in that said channel processing resource allocating and controlling unit is further configured to select a corresponding channel processing unit for each radio link in said corresponding cells, so that channel processing associated with said each radio link is performed in the selected corresponding channel processing unit, and uplink and downlink wireless signals in said corresponding cells are respectively allocated to at least one of the selected channel processing units.

14. The centralized base station according to claim 12, characterized in that said corresponding cells are all the cells associated with said centralized base station, and said channel processing resource allocating and controlling unit is further configured to control processing of uplink and downlink signals in said corresponding cells in the following manners:
in the uplink direction, the channel processing units allocated respectively for the uplink wireless signals of the cells perform processing of uplink physical channels corresponding to corresponding mobile terminals in the uplink wireless signals of the cells, respectively, and then processing results of the channel processing units are respectively sent to a user plane processing section of an interface unit between said centralized base station and an RNC/BSC to form uplink data frames; and
in the downlink direction, the channel processing units allocated respectively for the downlink wireless signals of the cells perform processing of the downlink physical channels corresponding to the uplink physical channels of the corresponding mobile terminals in the downlink wireless signals of the cells, respectively, and then downlink wireless signal components of the cells from the different channel processing units are respectively added up on the premise of guaranteed timing alignment, thereby compounding entire downlink wireless signals of the corresponding cells.

15. The centralized base station according to claim 12, characterized in that at least one channel processing unit allocated respectively for the uplink wireless signals of the corresponding cells is the same as at least one channel processing unit allocated respectively for the downlink wireless signals of said corresponding cells.

16. The centralized base station according to claim 12, characterized in that said corresponding cells are all the cells associated with said centralized base station, and said channel processing resource allocating and controlling unit is further configured to control processing of the uplink and downlink signals in said corresponding cells in the following manners:
in the uplink direction, the channel processing units allocated respectively for the uplink wireless signals of the cells perform the processing of the uplink physical channels corresponding to corresponding mobile terminals in the uplink wireless signals of the cells, respectively, and then processing results of the channel processing units are respectively sent to a user plane processing section of an interface unit between said centralized base station and an RNC/BSC to form uplink data frames; and
in the downlink direction, the correspondingly same channel processing units allocated respectively for the downlink wireless signals of the cells perform processing of the downlink wireless signals of the corresponding cells, respectively, so as to form downlink wireless signals of the cells.

17. The centralized base station according to claim 12, characterized in that said corresponding cells are cells selected from all the cells associated with said centralized base station, and said channel processing resource allocating and controlling unit is further configured to still allocate fixed channel processing units for the remaining cells other than said corresponding cells, and allocate corresponding channel processing units for a plurality of radio links selected from said corresponding cells based on the utilization situation of system channel resources, and control the allocated channel processing units to perform service channel processing of a part of users associated with the selected plurality of radio links in said corresponding cells, respectively.

18. The centralized base station according to claim 12, characterized in that said channel processing resource allocating and controlling unit is further configured to select an optimum channel processing unit for each newly-added radio link, and performs control so that the channel processing associated with each newly-added radio link is performed in the selected optimum channel processing unit, respectively.

19. The centralized base station according to claim 12, characterized in that said channel processing resource allocating and controlling unit is set in said MU (10) or outside said centralized base station.

20. The centralized base station according to claim 12, characterized in that said centralized base station further comprises a signal compounding unit for adding the downlink wireless signal components of the corresponding cells from the different channel processing units on the premise of guaranteed timing alignment, so as to respectively compound entire downlink wireless signals of the corresponding cells, wherein said signal compounding unit is set in said signal routing allocating unit, or is a functionality unit independent of said signal routing and allocating unit.

21. The centralized base station according to claim 12, characterized in that said centralized base station further comprises a waveform shaping filtering unit for performing waveform shaping filtering in the process of forming downlink wireless signals of the corresponding cells, and the waveform shaping filtering unit is set in said signal routing allocating unit or in said RRU, or is a functionality unit independent of said signal routing allocating unit.

22. The centralized base station according to claim 12, characterized in that the channel processing units allocated for the corresponding cells perform the following processing operations of a part of downlink physical channels associated with said corresponding cells, respectively: channel coding, multiplexing, interleaving, rate matching, modulation, spread-spectrum, scrambling, and waveform shaping filtering processing.

23. The centralized base station according to any one of claim 12, characterized in that the channel processing units allocated for the corresponding cells perform the following processing operations of a part of uplink physical channels associated with said corresponding cells, respectively: match filtering, de-spreading, channel estimation, RAKE combining, signal-to-interference ratio SIR estimation, de-interleaving, de-multiplexing and channel decoding operation.
